(19) United States
(12) Patent Application Publication
(10) Pub. No.: US 2004/0044953 A1
(43) Pub. Date: Mar. 4, 2004

(54) Resource files for electronic devices

(76) Inventors: Andrew Watkins, Warwick (GB); Peter Chapman, Birmingham (GB); Regis Adjamah, Birmingham (GB); Thierry Bavoux, West Midlands (GB)

Correspondence Address: Gottlieb Rackman & Reisman, 270 Madison Avenue, New York, NY, 10016-0601, US

(21) Appl. No.: 10/432,180

(22) PCT Filed: Nov. 19, 2001
(86) PCT No.: PCT/GB01/05091

(30) Foreign Application Priority Data
Nov. 18, 2000 (GB) 0028209.5
Aug. 1, 2001 (GB) 0118762.4

(51) Int. Cl. G06F 17/00

(52) U.S. Cl. 715/500

(57) ABSTRACT

A resource file (36) comprises resource data defining one or more resources usable by embedded application program means (32) for operating a user interface of an electronic device (11). The resource file (36) is separate from the application program means (32) and the resource file (36) has a searchable structure.

The invention relates generally to resource files for electronic devices having a user interface. More particularly, but not exclusively, the invention relates to resource files for handheld electronic devices having limited memory and embedded applications programs, for example mobile cellular telephone handsets.

Generally, during manufacture of known mobile telephone handsets, the various applications programs and associated resources necessary for operating a handset are embedded in the handset together. The applications programs are provided with information relating to specific. addresses in the device memory for locating and accessing respective resources.

In accordance with the invention, a resource file is provided comprising resource data defining one or more resources usable by embedded application program means for operating a user interface of an electronic device; wherein the resource file is separate from that of the application program means and has a searchable structure.

Preferably, the resource file has a respective identifier allocated to each respective resource and type of resource, whereby each said resource is locatable, in use, by the application program means, regardless of the resource's size and location in the searchable resource file or the location of the searchable resource file in the device.

This facilitates the provision of a relocatable (that is, redispositionable) and replaceable searchable resource file in that, in use in the device, there is no dependency on specific memory addresses and no predefined hard-wired link between a specific resource and its associated application code. Thus, a specific resource can be replaced by an alternative version of that resource of a different size and in a different position in the searchable resource file, without necessitating any change to the application program means.

The searchable resource file may be a binary file having a hierarchical structure.

Preferably, the location of the resource file within the electronic device is independent of the application program means.

In a preferred embodiment the application program means comprises an application programmers interface (API). The API may capable of searching one or more resource files for required resource data. The resource file may comprise a signature that is recognisable by the API such that the API may be capable of searching through the memory of the device in order to detect the resource file and determine its location in memory.

Preferably, the resource file is compilable C code. The resource file may be raw binary and/or ASCII Hex, and may be encrypted and/or compressed.

In accordance with a further aspect of the invention, there is provided machine readable code which, when run on the electronic device, causes the device to effect a searchable resource file as described above. This code is referred to below as “searchable resource file code”.

In accordance with a still further aspect of the invention, there is provided carrier means for machine readable code, the carrier means carrying the searchable resource file code described above.

In accordance with a still further aspect of the invention, there is provided application program means operable to access respective resources in the searchable resource file (SRF) described above, regardless of the resources' respective sizes and locations in the SRF or the location of the SRF in a memory, by virtue of information contained in the application program means concerning identifiers allocated to respective resources and types of resources in the SRF.

In accordance with a still further aspect of the invention, there is provided machine readable code which, when run on an electronic device, causes the device to effect the application program means described above.

In accordance with a still further aspect of the invention, there is provided the application program means described above, embedded in an electronic device.

In accordance with a still further aspect of the invention, there is provided a method for manufacturing an electronic device having a user interface, the method comprising the steps of:

providing an at least part-completed electronic device having stored therein embedded code which, when run on the device, causes the machine to effect application program means for carrying out essential functions of the device;

adding to the device the searchable resource file code described above such that, when said codes are run on the device, communications are established between the searchable resource file and the associated application program means.

This facilitates incorporation in the device, at an advanced stage of the manufacturing process, of resources which define the “look and feel” of the user interface. Many part-completed devices including embedded application program code can thus be manufactured and subsequently adapted to particular present requirements of a customer of the manufacturer, for example at a much later stage in the manufacturing process or subsequent to sale.

Preferably, said embedded code contains information in accordance with an application programmer's interface (API), concerning which of the identifiers is associated with each respective resource and resource-type.

This is a convenient manner of facilitating that the application program means can readily locate a stored user-specified resource regardless of its size and location in the resource file or the location of the resource file in the device.

The API may include at least some of the following information: identifier values for respective resource-types; identifier values for respective resources; function calls to initialise the device with a new searchable resource file code; function calls to return specific resources; and function calls to count and enumerate resources of specified type.

Conveniently, the adding step comprises transferring the searchable resource file code into a memory via a serial data link or via a wireless communications network.

Preferably, the memory is in the electronic device, or an accessory for the device.

In this manner, addition of the “look and feel” of the user interface can be controlled remote from a present location of the device. The device may, for example, be located at its place of manufacture or other place of storage prior to distribution. The interface designer can thus exert full control of the adding of the “look and feel” data from the remote location and adapt it during a late stage of manufacture if necessary. This provides greater flexibility in the manufacturing process, and facilitates better control of unauthorised production and copying of the completed devices.

Alternatively or additionally, the adding step may comprise transferring the searchable resource file code into a non-volatile memory device, for later connection to the electronic device.

The memory device may be incorporated in a clip-on accessory or in a card, for enabling connection of the memory device with the electronic device.

The memory device may remain connected with the electronic device for enabling direct interaction of the searchable resource file stored on the memory device with the application program means.

Alternatively, the searchable resource file may be downloadable into the electronic device, for enabling the memory device to be later removed. Conveniently, additional searchable resource file code is stored in the electronic device contemporaneously with said embedded code relating to the application program means.

The additional searchable resource file code, when run on the electronic device, may cause the device to effect a default resource file in the absence of a functioning, subsequently incorporated, searchable resource file.

Preferably, the method comprises the further step of using a human-readable Resource Definition File (RDF) to select resource data relating to presently desired resources for generating said searchable resource file.

This enables the searchable resource file-to be limited to those resources desired in a particular species of the electronic device by a particular customer of the device manufacturer.

According to a still further aspect of the present invention a method of providing an electronic device with the searchable resource file code described above comprises transferring the resource file to the electronic device via a mobile network.

In a preferred embodiment the resource file code is transferred using a short message service (SMS) message or a plurality of concatenated SMS messages.

The resource file code may be transferred via a data connection such as WAP.

The resource file code may be transferred via an unstructured supplementary services data (USSD) message.

According to a still further aspect of the present invention, a method of providing an electronic device with the resource file code described above comprises the steps of storing the resource file in a multimedia card (MMC), and inserting the MMC into the electronic device.

According to still another aspect of the present invention a method of providing an electronic device with the resource file code described above comprises the steps of connecting an accessory to the electronic device, the accessory having an area of memory in which the resource file code is stored, and downloading the resource file code from the accessory to the electronic device.

The accessory may be a clip on cover.

The methods of providing an electronic device with the resource file code may further include the step of compiling a human-readable Resource Definition File (RDF) comprising data relating to resources. The RDF may be an XML notation.

The RDF may be generated using user interface design tools or from form driven user customisation tools. Alternatively the RDF may be manually edited.

Conveniently, the structure of the RDF code and the hierarchical structure of the searchable resource file code are similar.

In accordance with a still further aspect of the invention, there is provided a signal having digitally encoded therein the searchable resource file code described above.

In accordance with a still further aspect of the invention, there is provided a clip-on component for fitting to the electronic device in an advanced stage of manufacture, the component having stored therein the searchable resource file code described above, and having connection means for establishing communications between the searchable resource file and the associated application program means.

In accordance with a still further aspect of the invention, there is provided an electronically readable card having stored thereon the searchable resource file code described above, the card being adapted to communicate with the electronic device via a peripheral connection of the device.

According to still another aspect of the present invention there is provided an electronically readable card having stored thereon the searchable resource file code, the card being adapted to communicate with the electronic device via a peripheral connection of the device.

According to a still further aspect of the present invention there is provided an accessory having stored thereon the searchable resource file code, the accessory being adapted to communicate with the electronic device via a peripheral connection of the device. The accessory may be a clip-on cover.

The advantages provided are that the “look and feel” of the user interface of the handset 11 can be updated automatically, under the control of the network rather than the user. It is also possible to temporarily update the user interface to display, for example, advertisements when certain actions are taken by the user for a given period of time, providing the potential for further revenue to network operators etc. Such advertisements could also be in the form of audio signals, which are played to the user, or a combination of audio and visual advertisements.

In accordance with a still further aspect of the invention, there is provided an electronic device having stored therein the searchable resource file code described above and/or said application program means operable to access respective resources in said searchable resource file.

Advantageously, the electronic device is a wireless telecommunications device, for example a mobile cellular telephone handset.

The electronic device may be provided with means for receiving a software carrier means and for reading therefrom the searchable resource file code. The receiving means may be adapted to receive an electronically readable card having the searchable resource file code stored thereon. Alternatively the receiving means may be adapted to receive an accessory having the searchable resource file code stored thereon. The accessory may be a clip-on cover.

In accordance with a still further aspect of the invention, there is provided means for manufacturing an electronic device having a user interface, the means comprising:

data storage means having stored thereon:

resource data relating to one or more resources usable, in use in the electronic device, by application program means for operating the user interface;

application program interface (API) means operable to provide information as to identifiers associated with each respective resource and resource-type; and

resource definition file (RDF) means operable to select required resource data on the basis of a customer specification; and

compiler means connectable to the data storage means and operable to arrange the selected resource data into a searchable resource file structure, including allocating a respective one of said identifiers to each respective resource and type of resource in accordance with information provided by the API, to thereby enable the application program means to locate a stored user-specified resource regardless of the size or location of the specified resource in the resource file or the location of the resource file in the device.

Preferably, the compiler means is also operable to output the searchable resource file in a form of code suitable for transfer to a memory via a serial data link or wireless communications link.

According to a still further aspect of the present invention there is provided a software development kit (SDK) comprising machine readable code which, when run on an electronic device, causes the device to effect the RDF described above and documented interfaces for the API.

Preferably, the SDK further comprises an example compiler and resource data for demonstration purposes.

According to a still further aspect of the present invention there is provided a carrier for machine readable code carrying the SDK described above.

It will be appreciated that the term “device” as used herein includes part-completed devices.

In order that the invention may be better understood, an example thereof will now be described, by way of example only, with reference to the accompanying drawings, in which:

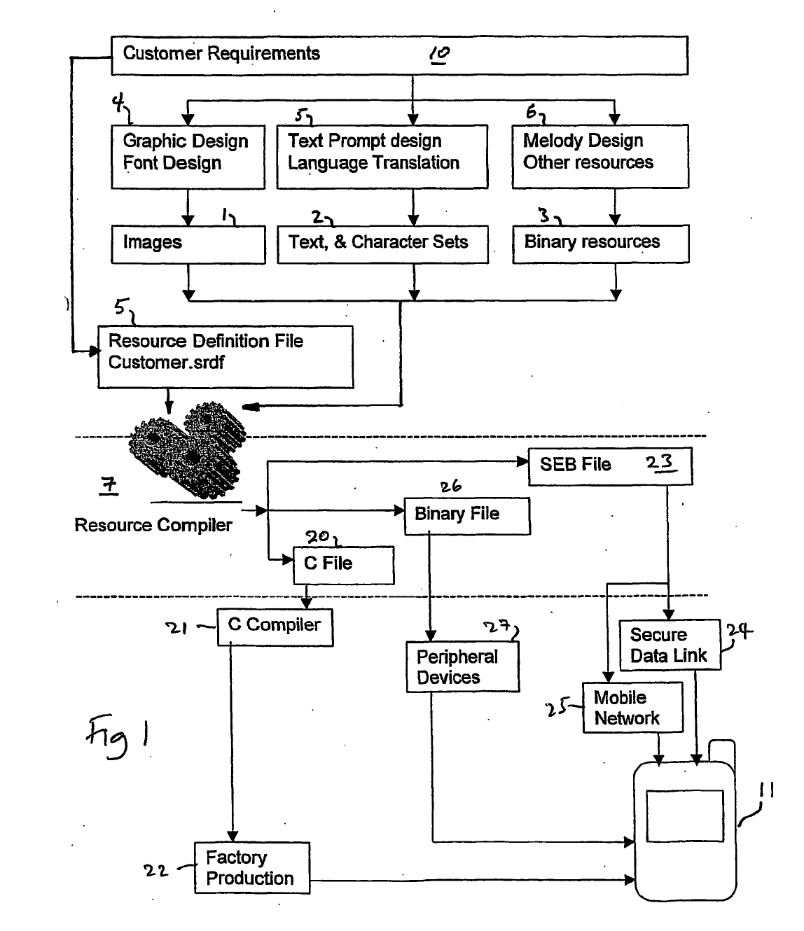

FIG. 1 is a diagram illustrating the flow of information in a process for providing a searchable resource file to a wireless telecommunications device having a user interface;

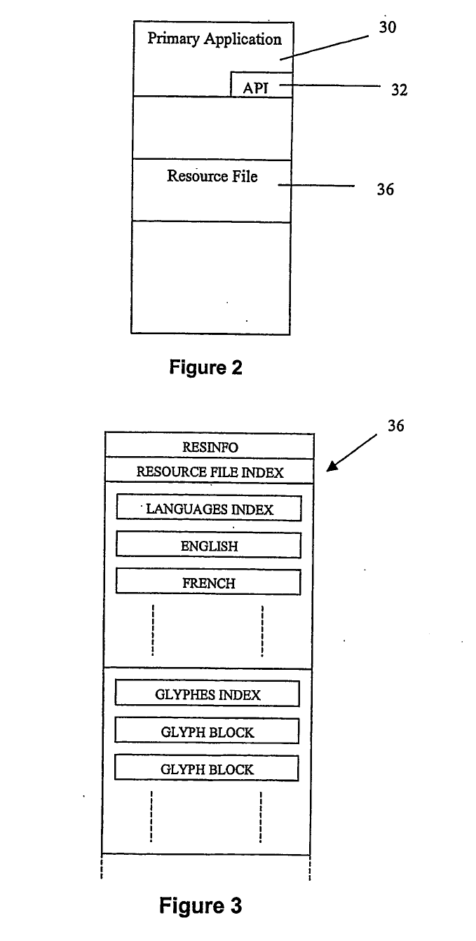

FIG. 2 is a representation of a memory of an electronic device for storing searchable resource file information;

FIG. 3 is a representation of a resource file for storage in the memory of FIG. 2;

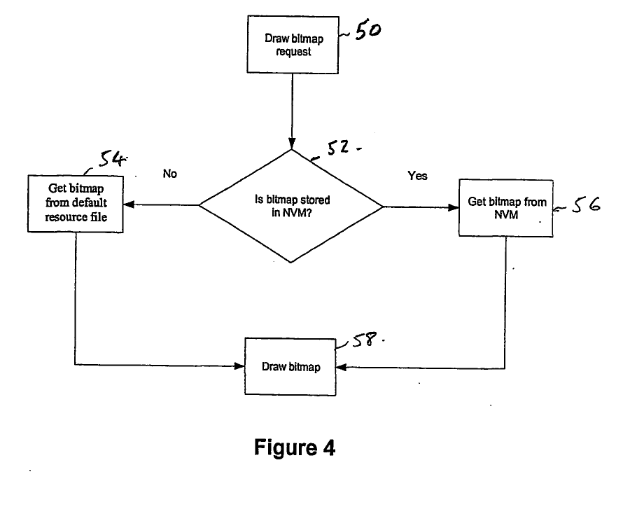

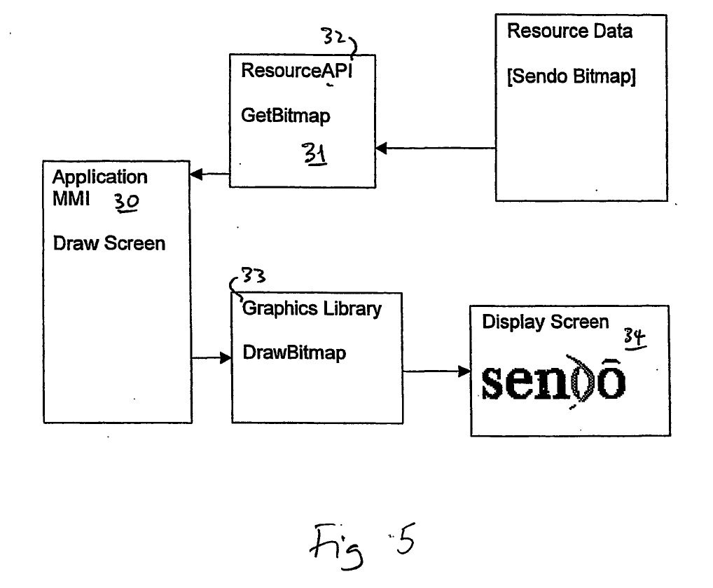

FIG. 4 is a diagram illustrating a process whereby the electronic device obtains resource information;

FIG. 5 represents the flow of resource data within the device; and

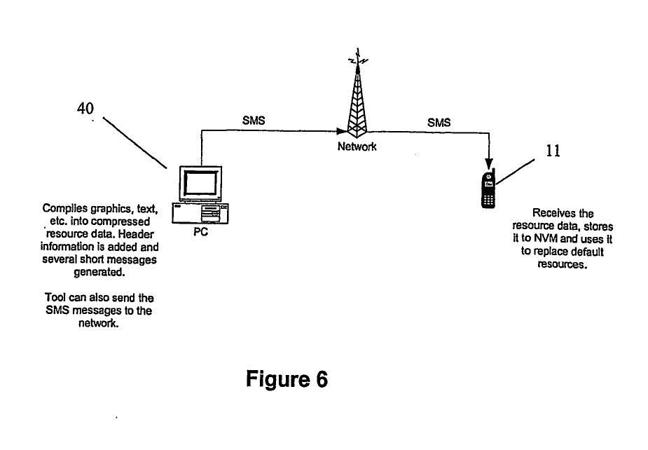

FIG. 6 is a schematic illustration of the transferring of the resource file to the electronic device over a mobile network.

Referring to FIG. 1, a process is illustrated for providing a searchable resource file to a wireless communications device, in the form of a mobile cellular telephone handset 11, having a user interface. Resource data is generated in native format in the form of images 1, text and character sets 2, binary resources 3 and any other appropriate type of resource. The resource data is developed in response to new customer requirements 10. The customer may be a network operator, regional vendor or handset supplier or any third party wishing to develop a new personality for the handset. The customer specifies, for example, what prompts and languages resources are required and whether new fonts, bitmaps and images resources are required. These requirements are then passed onto graphic, font, text prompt and melody designers 4,5,6 who create the native format resources 1,2,3, and translators who create the various language versions.

A resource integrator creates a human-readable resource definition file (RDF) 5 relating to the resources and the relationships between them. The resource definition file is an XML notation, both human readable and suitable for machine processing, that allows a designer to select from the resource data the required resources for a given client. The RDF 5 can be generated as the output from user interface design tools or from form driven user customisation tools or hand edited. In the RDF 5 some resources are specified explicitly, for example textual prompts for various languages are listed directly. Other resources are specified by references to ‘native format’ data files such as windows bitmaps for graphics or MIDI files for music. Glyphs comprising one or more data files (for example bitmaps) are used to specify display formats such as animations. The notation gives the designer freedom to change the personality of the user interface whilst ensuring that all essential information is provided to the system. In this connection, a resource of a particular type is made available for each of the ID ranges in use.

An example of the RDF 5 is as follows:

<rdf xmlns:HTML=“http://www......”id=“Sendo_Standard” VER=“1.0” DATE=“2001/07/09”>

<resinfo>

<id>Sendo Staridard</id>
<version>1.0</version>
<date>2001/07/09</date>
<author>Andrew Watkins</author>
<copyright>Sendo Ltd 2001 </copyright>

</resinfo>
<languages>

<language>

<id>Engish</id>
<pr>English</pr>
<pr>Call</pr>
<pr>OK</pr>
<pr>Enter PIN</pr>
...
...

</language>
<language>

<id>French</id>
<pr>Francais</pr>
<pr>Appel</pr>
<pr>OK</pr>
<pr>Entrer PIN</pr>
...
...

</language>
...
...

</languages>
<glyphs>

<glyphblock ID=“Latin1” FONT=“SENDO_BOLD” SIZE=“9” START=“0020” END=“007F”>

<glyph ID=“0020” SRC=“bitmaps\sendo_bold\sendo_bold_0020.bmp” />
<glyph ID=“0021” SRC=“bitmaps\sendo_bold\sendo_bold_0021.bmp” />
<glyph ID=“0022” SRC=“bitmaps\sendo_bold\sendo_bold_0022.bmp” />
<glyph ID=“0023” SRC=“bitmaps\sendo_bold\sendo_bold_0023.bmp” />
<glyph ID=“0024” SRC=“bitmaps\sendo_bold\sendo_bold_0024.bmp” />
...
...
<glyph ID=“007F” SRC=“bitmaps\sendo_bold\sendo_bold_007F.bmp” />

</glyphblock>
<glyphblock ID=“UTC_SENDO_ANIMATIONS” START=“E000” END=“E01F”>

<glyph ID=“SENDO_ANIM_POWER_ON”>

<bmpSRC=“bitmaps\animations\power_on\res_welcome_screen_01.bmp” />
<bmp SRC=“bitmaps\animations\power_on\res_welcome_screen_02.bmp” />
<bmp SRC=“bitmaps\animations\power_on\res_welcome_screen_03.bmp” />
<bmp SRC=“bitmaps\animations\power_on\res_welcome_screen_04.bmp” />
<bmp SRC=“bitmaps\animations\power_on\res_welcome_screen_05.bmp” />
...
...

</glyph>
...
...

</glyphblock>
...
...

</glyphs>
<melodies>

<mel ID=“MEL_LOW_BAT” SRC=“tunes\std\low_bat.mid”>low battery</mel>
<mel ID=“MEL_SMS_ALRT” SRC=“tunes\std\sms_alert.mid”>sms alert</mel>
<mel ID=“MEL_SWITCH_OFF” SRC=“tunes\std\switch_off.mid”>switch off</mel>
...
...

</melodies>

</rdf>

In this example of the notation for RDF 5, tags are used to specify the various resources to be included in the final resource file.

The first line identifies the RDF 5 by name and date. This is followed by information about the RDF 5 itself, such as its version, date of creation, author, etc. This information is located between the tags <resinfo> and </resinfo>.

The next part contains the languages information, which is contained within the <languages> and </languages> tags. For each language included, for example English, French etc, there is a separate section located between <language> and </language> tags. Each section contains a language ID, as well as the various text string prompts required in the appropriate language.

Following the language information is the glyph information. Within this section are provided references to the various native format data files for the glyphs.

Finally there is a section within which there are provided the various native format data files for the various melodies to be provided on, for example, the handset.

The present invention is not limited to only those resources or the above example, but can encompass any resource required.

The notation allows for the addition of new resource file data types without loss of backward compatibility, that is, the notation is extendable. For example, new attributes can be added to the tag for a given resource, such as addition of a compression attribute to a bitmap tag without breaking existing compilers, which will happily ignore it.

The RDF 5 is then sent to a compiler 7 and compiled into a binary format that can be loaded into the handset 11 either during production of a basic handset module, which may not be a complete handset, at final configuration time or after delivery via various peripherals.

The compiler 7 uses the RDF 5 to locate the required resources in their native format, converts these to appropriate internal formats, and arranges them in a location-independent binary storage format so that they form a searchable resource file. During arrangement of the resource data by the compiler, an identifier is allocated to each respective resource and type of resource in accordance with information implicit in the RDF, based on a functional specification provided by an Application Programmers Interface (API), so that the required data can be searched and accessed.

FIG. 2 illustrates an example of a primary application code 30 and a resource file code 36 located in the memory of the handset 11 of FIG. 1. The primary application 30 includes an API 32. The resource file 36 is located separate to the primary application 30. The start address of the resource file 36 is known to the API 32. In one embodiment the resource file 36 is provided in a specific location in memory, whereby the start address is always known, and so the API 32 always knows where to look.

Where one or more further resource files are added, the resource file 36 becomes a default resource file. It is necessary for the API 32 to determine whether a particular resource is located in the default resource file 36 or in a subsequent resource file. In order to achieve this a lookup table is provided. The default resource file 36 is in general embedded in ROM, whilst any other resource files will be located in non-volatile memory (NVM) other than ROM. The lookup table contains associated IDs for resources contained in NVM. If the required resource is not located in the NVM then there will be no ID entry in the lookup table, and so the API 32 knows to obtain that particular resource from the default resource file 36.

FIG. 3 shows a schematic representation of the resource file 36 of FIG. 2, and the resource information contained therein.

In FIG. 4 an example is illustrated of a process for obtaining information contained in a bitmap resource, for generating a graphical display. A request is received at step 50 for a particular bitmap resource. The API 32 (see FIGS. 1 and 2) determines the relevant ID for the particular resource data, and then, at step 52, goes to a lookup table to determine whether the particular ID is located in the NVM. If the resource ID is not present in the lookup table, then, at step 54, the API 32 retrieves the bitmap from the default resource file 36.

If however the resource ID is in lookup table, the API 32 retrieves the bitmap from the resource file in the NVM at step 56. The lookup table may also include information about where the relevant resource file is located in the NVM, which will aid in differentiating between a plurality of resource files that could be locate in the NVM. At step 58 the graphical information in the bitmap is used to generate a display.

In an alternative embodiment the resource file has a signature that is recognised by the API 32, allowing the API 32 to search for the start of the resource file. This provides greater flexibility in the location of the resource files. This also allows for subsequent further resource files to be added, which are each identified by the API. In such circumstances, once the API 32 has recognised the existence of more than one resource file, the resource file with the latest date is searched first for the required resources, followed by the remaining resource files in chronological order until a resource with the relevant ID is found.

The primary application 30, including the API 32, is located in memory such as ROM, flash or some other form of non-volatile memory. Resource file(s) may either be located within the same area of memory, or may be located within another area of memory, possibly even a remote area of memory. For the resource file the memory in which it is located could either be non-volatile memory or memory such as RAM, and loaded each time the power to the handset 11 is switched on.

The API (Application Programmers Interface) allows the primary application to find and access individual resources as and when required. The API is both a functional specification and a set of instructions in the code. It is provided as part source code in the form of a C header file and a binary code module (interface) containing the implementation. The code module may be provided as part of a software development kit. The API functional specification for implementation on a given handset architecture specifies:

Numeric identifier values for resource-types—Resource-type IDs.

Numeric values for individual resources—Resource IDs.

Function calls to initialise the resource system with a new resource file.

Function calls to return instances of specific resources e.g. prompt, character bitmap, melody etc.

Function calls to count and enumerate resources of various types.

A purpose of the API is to protect the application from the details of the implementation, which may change from time to time.

Wherever appropriate international standards are used to allocate the resource IDs. For example all characters and bitmaps used in the API are identified by their Unicode UCS2 character value. This includes English and European characters, Asian and Arabic characters, and commonly used symbols.

A key requirement of the system is that the run time executable code that comprises the resource file API can always find and access individual resources within the resource file irrespective of the absolute location in memory of the resource file or the actual size and location of the resource within the data file itself.

An example of the binary searchable resource file is that illustrated in FIG. 3 which has a hierarchical structure similar to that used in the text based Resource Definition File 5. Once initialised with the start address of the data file the API can quickly recursively search and locate an individual resource based only on the type of resource required and the Resource ID. This directory structure is optimised to minimise access time for resources and/or the space required to store the directory information.

The searchable resource file structure makes provision for extra directory level data to be stored at each level allowing for special features such as decompression tables for compressed resources and common header information for groups of similar resources. The file structure also allows for searches to fail gracefully by returning near match resources when the specific resource required is not present—for example returning an alternative similar character if the requested character is not present.

Furthermore, the searchable resource file structure allows for ‘discovery’ and ‘enumeration’. For example a variable number of different languages may be present in any given resource file. Enumeration functions allow the user interface code to discover the actual number of languages present and to display these as a list for the user to select their preferred language.

The selected language ID is then used again by the resource file API to change all the prompts used by the handset to the new language. This means that it is possible to add new languages to the system that were not envisaged at the time the original application was written.

A key feature is that the user interface obtains from the resource API a list of prompts and uses the list to construct a menu. An ID is associated with each prompt. Once a user has made a selection, the user interface passes the ID to the resource API to select the language. The user interface code is never aware which language it is using or even that, say, ID 9 represents English.

The compiler is operable to output the binary version of the resource file in a variety of formats including: compilable C code, Raw binary, ASCII Hex, and encrypted binary format. These different representations make the resource file available to be transferred into the handset 11 by a variety of transfer mechanisms.

When the resource file compiler 7 outputs the searchable resource file as C code 20, the code is then compiled as normal in a C-compiler 21 with the application for embedding during factory production 22 in a part-completed handset. This provides the application with a default set of resources to be used if no other is provided.

When the resource file compiler 7 outputs the searchable resource file as an Encrypted Binary file 23, the file 23 is suitable for transfer to the handset, or an accessory such as a clip-on cover, via a secure serial data link 24. The compiler 7 may output, along with the encrypted file 23, signature information that can be used to verify that the file 23 has not been modified, and which discourages or prevents reverse engineering of the raw data file format. Alternatively or additionally, the encrypted binary file 23 may be transferred to the handset 11 via a mobile network 25 and the handset's mobile network interface.

When the binary file 23 is transferred to the handset 11 via the mobile network 25 and the handset's mobile network interface, in order to reduce the amount of data transferred, and thereby reduce the time taken and the costs involved, preferably the encrypted binary file 23 is compressed prior to the transfer. The compression may be achieved using any known compression method.

When the compressed file is received by the handset, it can be decompressed prior to storing in memory. However, the amount of memory required to store the file can be reduced by storing it in compressed form on the handset 11. In this case the resource file header includes an indication that the file is compressed so that it can be decompressed when it is required to obtain resource information from the file.

The header may also include details of the method of compression used in order to facilitate decompression of the file. Alternatively the file may be compressed using a predetermined method.

When the resource file compiler 7 outputs the searchable resource file as ASCII hex and Raw Binary, the file 26 is suitable for storing in various Non Volatile Memory devices such as ROM, PROM, EEPROM, FLASH EEPROM, compact flash (CF) and MMC cards. These devices can be used in peripheral connecting devices 27 on the handset, such as in a clip on cover or card slot. In these cases the searchable resource file code may be copied into the handset 11 through the peripheral interface allowing the later removal of the peripheral or may reside permanently in the peripheral device 27.

FIG. 5 shows an example of the flow of information in the handset 11. The user interface in the form of an MMI (Man Machine Interface) part 30 of the handset application decides to display the welcome screen. This is identified by the resource ID E001, for example. It calls the resource API function getBitmap 31 with this value and is returned a reference to the bitmap. The resource API 32 will locate the bitmap in the resource data file and if necessary de-compress it or otherwise pre-process it so that it is ready for use. The resource reference value is then passed to the graphics library 33, which then calls more specific resource API functions to obtain information about the bitmap such as its size and shape and finally the actual bits in a format suitable for transferring to the display screen 34.

All the “resources” data representing the look and feel of the user interface is separate from the primary executable code. This provides a key functional feature of the invention: that the resource file is re-locatable and therefore replaceable. There is no dependency on specific memory addresses in the resource file and no pre-defined hard-wired link between a specific resource such as a bitmap and the application code that uses it. This means that an alternative version of the bitmap can replace the original being both a different size and position in the file and yet still be used without any changes to the original application.

The term ‘resources’, includes the following:

Text prompts in various languages.

Images in the form of bitmaps, icons and animations.

Bitmaps representing the character sets used in various languages.

Music used for ringer melodies and system events such as battery low warning tones.

Menus.

Information specifying the position, style and orientation of objects such as text and graphics on the handset display device (also called zones).

Version information.

Dictionaries for ambiguous text input in various languages (T9 data).

Other binary and text data.

The RDF notation 5 can be bypassed and a binary form of the resource file generated directly from an interactive composition tool.

The precise format of the binary resource data can be varied so long as it maintains the key features of independence of location and the discovery and enumeration features.

The resource binary data can be split into several separate sub units allowing concepts such as a core set of resources with ‘add on’ extensions such as extra melodies or game levels. For example, the core set of resources may be provided in a default resource file. Subsequent resource files can then be downloaded, which could contain resources for anything from a single bitmap or melody, to entire menus, languages, game levels or even entire games.

The mapping IDs for specific resource file types and resource elements are subject to the requirements of the customer and may therefore change. For example a later version of the handset software may support new functions that require additional prompt IDs to be allocated.

The storage of the resource file binary in an encrypted format and its transfer to the handset via a secure link are optional. However they provide a key element of security against unauthorised modification of the resources or download of personalities by unlicensed third parties.

The invention can be applied to any generic embedded device that supports a text or graphical user interface. It is appropriate wherever such a device may be required to be customised by language or look and feel after the initial construction.

The resource file tools and Resource file API C code can be packaged as a software development kit (SDK) that can be used to provide this functionality to any such devices.

The searchable resource file structure can be arranged to support any type of data that is independent of absolute memory locations. This means that the invention could be used to deliver modules of functionality to the handset complete with associated resources. For example the handset may support a virtual machine for games that runs a byte code based language such as Forth or Java. Games written for this virtual machine can be stored complete with sounds and images used by the game in the resource file and added or downloaded through the previously specified channels.

The resource file concept coupled with a manufacturing process that allows for late stage configuration of the handset allows all devices to be manufactured identically and to be configured with customer specific resources immediately before delivery. This is a significant and original step beyond known processes for handset manufacturing.

As previously mentioned, the present invention allows for the downloading of additional updated resources to the handset 11, for example via a serial data link, via a mobile network, a multimedia card (MMC) or via accessories such as clip on covers having non-volatile memory provided therein.

FIG. 6 is a schematic illustration of the transferring of the resource file over a mobile network.

The resource definition file 5 and native format resources 1,2,3 of FIG. 1 are either created on or transferred onto a PC 40. The PC 40 then compiles the native format resources 1, 2, 3 and the resource definition file 5 to produce the resource file.

The resource file is preferably in the form of an encrypted binary file, which is compressed in order to reduce the amount of data that is to be transferred.

Header information, including attributes identifying the exact resource(s) and type of compression used, is pre-pended to the resource data.

The resulting binary data can then be transferred to the handset using, for example, the GSM Short Message Service (SMS). In general, it is likely that the amount of data required to be transferred is more than can be incorporated into a single SMS message. When this is the case, the data is divided into smaller parts and transferred using concatenated SMS (in accordance with GSM recommendation 03.40).

The use of compression allows fewer SMS messages to be sent, thereby reducing the costs involved in transferring the resource data.

Alternatively the resource data can be transferred to the handset during a data connection such as WAP, or via an unstructured supplementary services data (USSD) message.

When the handset 11 receives the resource data it stores the information in an area of non-volatile memory. Preferably this action is hidden from the user. However, a message may be displayed informing the user that a transfer has taken place.

The next time the API 32 is required to retrieve the resource(s) relating to the data that has been transferred, the new resource data is retrieved instead of the default or previous relevant resource data, and where appropriate decompressed and de-encrypted.

If the resource file transferred to the handset 11 is only temporary, or for any other reason requires removal, a further SMS message can be sent to the handset, instructing it to remove at least a part of the header of the resource file so that the API 32 no longer recognises the resource file.

Alternatively, where a lookup table is used to determine the location of a resource, any entry in the lookup table relating to that particular resource file can be removed. This may also be achieved during a data connection such as WAP, or via a USSD message.

When the resource file is removed, the next time the API 32 is required to retrieve the resource relating to the data that has been transferred, the previous relevant resource data will be retrieved.

In this way, the display of the handset 11 can be altered by network operators, service providers, etc. without the interaction of the user.

An alternative to transferring resource files over a mobile network is to provide them in peripheral connecting devices on the handset. In one example, a multimedia card (MMC) comprising non-volatile memory could include a resource file in the memory. Means are provided for connecting the MMC to the handset 11, for example by insertion into a MMC slot provided on the handset. On detection of the MMC, if the handset 11 operates with a lookup table as described above, the relevant resource IDs are read from the MMC and added to the lookup table. Alternatively, the resource file on the MMC could be detected by the API 32 and searched in chronological order with other resource files available to the API 32.

In another example, the resource file is incorporated into a non-volatile memory provided in a cover or other accessory of the handset 11, and handled in the same manner as for the MMC. In this way covers or other accessories which are normally provided for cosmetic purposes can include a resource file providing resources that “match” the cosmetic “personality” of the cover. Resource files included with accessories for the handset 11 can be downloaded from the accessory to RAM in the handset 11, providing the necessary resources for the accessory.

1. A resource file comprising resource data defining one or more resources usable by embedded application program means for operating a user interface of an electronic device; wherein the resource file is separate from the application program means and the resource file has a searchable structure.

2. A resource file according to claim 1 wherein a respective identifier is allocated to each respective resource and type of resource, whereby each said resource is locatable, in use, by the application program means, regardless of the resource's size and location in the searchable resource file or the location of the searchable resource file in the device.

3. A resource file according to claim 1 or claim 2 wherein the searchable resource file is a binary file having a hierarchical structure.

4. A resource file according to any preceding claim wherein the location of the resource file within the electronic device is independent of the application program means.

5. A resource file according to any preceding claim wherein the application program means comprises an application programmers interface (API).

6. A resource file according to claim 5 wherein the API is capable of searching one or more resource files for required resource data.

7. A resource file according to claim 5 or claim 6 wherein the resource file comprises a signature that is recognisable by the API such that the API is capable of searching through the memory of the device in order to detect the resource file and determine its location in memory.

8. A resource file according to any preceding claim wherein the resource file is compilable C code.

9. A resource file according to any preceding claim wherein the resource file is raw binary and/or ASCII Hex.

10. A resource file according to any preceding claim wherein the resource file is encrypted and/or compressed.

11. Searchable resource file code comprising machine readable code which, when run on the electronic device, causes the device to effect a searchable resource file in accordance with any one of claims 1 to 10.

12. Carrier means for machine readable code, the carrier means carrying the searchable resource file code in accordance with claim 11.

13. Application program means operable to access respective resources in the searchable resource file (SRF) of claims 1 to 10, regardless of the resources' respective sizes and locations in the SRF or the location of the SRF in a memory, by virtue of information contained in the application program means concerning identifiers allocated to respective resources and types of resources in the SRF.

14. Machine readable code which, when run on an electronic device, causes the device to effect the application program means of claim 13.

15. Application program means according to claim 13, embedded in an electronic device.

16. A method for manufacturing an electronic device having a user interface, the method comprising the steps of:
providing an at least part-completed electronic device having stored therein embedded code which, when run on the device, causes the machine to effect application program means for carrying out essential functions of the device;
adding to the device the searchable resource file code of claim 11 such that, when said code is run on the device, communications are established between the searchable resource file and the associated application program means.

17. A method-according to claim 16 wherein said embedded code contains information in accordance with an application programmer's interface (API), concerning which of the identifiers is associated with each respective resource and resource-type.

18. A method according to claim 17 wherein the API includes at least some of the following information: identifier values for respective resource-types; identifier values for respective resources; function calls to initialise the device with a new searchable resource file code; function calls to return specific resources; and function calls to count and enumerate resources of specified type.

19. A method according to any one of claims 16 to 18 wherein the adding step comprises transferring the searchable resource file code into a memory via a serial data link or via a wireless communications network.

20. A method according to claim 19 wherein the memory is in the electronic device, or an accessory for the device.

21. A method according to any one of claims 16 to 19 wherein the adding step comprises transferring the searchable resource file code into a non-volatile memory device, for later connection to the electronic device.

22. A method according to claim 21 wherein the memory device is incorporated in a clip-on accessory or in a card, for enabling connection of the memory device with the electronic device.

23. A method according to claim 21 or claim 22 wherein the memory device remains connected with the electronic device for enabling direct interaction of the searchable resource file stored on the memory device with the application program means.

24. A method according to claim 21 or claim 22 wherein the searchable resource file is downloadable into the electronic device, for enabling the memory device to be later removed.

25. A method according to any one of claims 16 to 24 wherein additional searchable resource file code is stored in the electronic device contemporaneously with said embedded code relating to the application program means.

26. A method according to claim 25 wherein the additional searchable resource file code, when run on the electronic device, causes the device to effect a default resource file in the absence of a functioning, subsequently incorporated, searchable resource file.

27. A method according to any one of claims 16 to 26 comprising the further step of using a human-readable Resource Definition File (RDF) to select resource data relating to presently desired resources for generating said searchable resource file.

28. A method of providing an electronic device with a searchable resource file code in accordance with claim 11, the method comprising transferring the resource file to the electronic device via a mobile network.

29. A method according to claim 28 wherein the resource file code is transferred using a short message service (SMS) message.

30. A method according to claim 29 wherein the resource file code is transferred using a plurality of concatenated SMS messages.

31. A method according to claim 28 wherein the resource file code is transferred via a data connection such as WAP.

32. A method according to claim 28 wherein the resource file code is transferred via an unstructured supplementary services data (USSD) message.

33. A method of providing an electronic device with a resource file code in accordance with claim 11, the method comprising the step of storing the resource file in a multimedia card (MMC), and inserting the MMC into the electronic device.

34. A method of providing an electronic device with a resource file code in accordance with claim 11, the method comprising the step of connecting an accessory to the electronic device, the accessory having an area of memory in which the resource file code is stored, and downloading the resource file code from the accessory to the electronic device.

35. A method according to claim 34 wherein the accessory is a clip on cover.

36. A method according to any one of claims 28 to 35 further including the step of compiling a human-readable Resource Definition File (RDF) comprising data relating to resources.

37. A method according to claim 36 wherein the RDF is an XML notation.

38. A method according to claim 36 or claim 37 wherein the RDF is generated using user interface design tools.

39. A method according to claim 38 wherein the RDF is generated from form driven user customisation tools.

40. A method according to claim 38 wherein the RDF is hand edited.

41. A method according to claim 27 or any one of claims 36 to 40 wherein the structure of the RDF code and the hierarchical structure of the searchable resource file code are similar.

42. A human-readable Resource Definition File (RDF) comprising data relating to resources for providing, in accordance with the method of any one of claims 36 to 40, a searchable resource file code in accordance with claim 11.

43. A RDF in accordance with claim 42 wherein the structure of the RDF code and the hierarchical structure of the searchable resource file code are similar.

44. A signal having digitally encoded therein the searchable resource file code of claim 11.

45. A clip-on component for fitting to an electronic device in an advanced stage of manufacture, the component having stored therein the searchable resource file code of claim 11, and having connection means for establishing communications between the searchable resource file and the associated application program means of claim 13.

46. An electronically readable card having stored thereon the searchable resource file code of claim 11, the card being adapted to communicate with the electronic device via a peripheral connection of the device.

47. An accessory having stored thereon the searchable resource file code of claim 11, the accessory being adapted to communicate with the electronic device via a peripheral connection of the device.

48. An accessory according to claim 47 wherein the accessory is a clip-on cover.

49. An electronic device having stored therein the searchable resource file code of claim 11 and/or the application program means of claim 13 operable to access respective resources in said searchable resource file.

50. The electronic device of claim 49 wherein the electronic device is a wireless telecommunications device.

51. The electronic device of claim 49 wherein the electronic device is a mobile cellular telephone handset.

52. The electronic device of any one of claims 49 to 51 wherein the electronic device is provided with means for receiving a software carrier means and for reading therefrom the searchable resource file code of claim 11.

53. The electronic device of claim 52 wherein the receiving means is adapted to receive an electronically readable card having the searchable resource file code stored thereon.

54. The electronic device of claim 52 wherein the receiving means is adapted to receive an accessory having the searchable resource file code stored thereon.

55. The electronic device of claim 54 wherein the accessory is a clip-on cover.

56. Means for manufacturing an electronic device having a user interface, the means comprising:
data storage means having stored thereon:
resource data relating to one or more resources usable, in use in the electronic device, by application program means for operating the user interface;
application program interface (API) means operable to provide information as to identifiers associated with each respective resource and resource-type; and
resource definition file (RDF) means operable to select required resource data on the basis of a customer specification; and
compiler means connectable to the data storage means and operable to arrange the selected resource data into a searchable resource file structure, including allocating a respective one of said identifiers to each respective resource and type of resource in accordance with information provided by the API, to thereby enable the application program means to locate a stored user-specified resource regardless of the size or location of the specified resource in the resource file or the location of the resource file in the device.

57. Means according to claim 56 wherein the compiler means is also operable to output the searchable resource file in a form of code suitable for transfer to a memory via a serial data link or wireless communications link.

58. A software development kit (SDK) comprising machine readable code which, when run on an electronic device, causes the device to effect a resource definition file (RDF) means to select required resource data on the basis of a customer specification and documented interfaces for an application program interface (API) means operable to provide information as to identifiers associated with each respective resource and resource-type.

59. The SDK of claim 58 further comprising an example compiler and resource data for demonstration purposes.

60. A carrier for machine readable code carrying the SDK of claim 57 or claim 58.
